(19) United States
(12) Patent Application Publication
(10) Pub. No.: US 2025/0300549 A1
(43) Pub. Date: Sep. 25, 2025

(54) REGULATOR NOISE COMPENSATION

(71) Applicant: Advanced Micro Devices, Inc., Santa Clara, CA (US)

(72) Inventor: Luca Ravezzi, Santa Clara, CA (US)

(21) Appl. No.: 18/609,643

(22) Filed: Mar. 19, 2024

(51) Int. Cl. H02M 1/44; H02M 3/155

(52) U.S. Cl. CPC H02M 1/44; H02M 3/155

(57) ABSTRACT

A regulator circuit is disclosed. The regulator circuit is configured to generate a regulated voltage for a load based on an unregulated supply voltage, the regulator circuit including a regulator, configured to receive the unregulated supply voltage and to generate the regulated voltage based on the unregulated supply voltage, where in the regulated voltage includes noise from the unregulated supply voltage; and a noise compensation circuit configured to amplify noise of the unregulated supply voltage, and to inject the amplified noise onto the regulated voltage.

### BACKGROUND

Low drop-out voltage regulators must often achieve tight supply noise rejection (PSRR) over a wide spectrum of operation. Good PSRR can be obtained within the bandwidth of the regulator feedback loop. However, PSRR quickly degrades outside the loop bandwidth, reaching a peak, before dropping again, for example, because of the load capacitance.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a regulator circuit coupled with a noise compensation circuit, which collectively provide a low noise regulated voltage for a load according to some implementations.

FIG. 2 illustrates a noise compensation circuit according to some implementations.

FIG. 3 illustrates a noise compensation circuit according to some implementations.

FIG. 4 illustrates a noise compensation circuit according to some implementations.

FIG. 5 illustrates a regulator circuit coupled with a noise compensation circuit, which collectively provide a low noise regulated voltage for a load according to some implementations.

FIG. 6 illustrates a noise compensation circuit according to some implementations.

FIG. 7 illustrates a noise compensation circuit according to some implementations.

FIG. 8 is a flowchart diagram illustrating a method of operating a regulator circuit coupled with a noise compensation circuit according to some implementations.

FIG. 9 is a graphical representation of PSRR for a regular circuit indicating supply noise rejection across frequency.

Corresponding numerals and symbols in the different figures generally refer to corresponding parts unless otherwise indicated. The figures are drawn to clearly illustrate the relevant aspects of the implementations and are not necessarily drawn to scale. The edges of features drawn in the figures do not necessarily indicate the termination of the extent of the feature.

### DETAILED DESCRIPTION OF ILLUSTRATIVE IMPLEMENTATIONS

The making and using of various implementations are discussed in detail below. It should be appreciated, however, that the various implementations described herein are applicable in a wide variety of specific contexts. The specific implementations discussed are merely illustrative of specific ways to make and use various implementations, and should not be construed in a limited scope. Unless specified otherwise, the expressions “about”, “around”, “approximately”, “substantially”, and other unspecifying terms signify values within expected variation resulting from, for example, design, measurement, and/or manufacturing tolerances of the specified value, as expected by those of skill in the art. Unless specified otherwise, the expressions “equal”, “similar”, “proportional”, or other relational terms are understood to signify or include that the relation is substantially equal, substantially similar, substantially proportional, etc.

Low drop-out voltage regulators are expected to achieve high supply noise rejection (PSRR) over their full spectrum of operation. High PSRR can generally be obtained within the bandwidth of the regulator feedback loop through regular regulator regulation operation. However, PSRR can quickly degrade outside the feedback loop bandwidth, reaching a peak, and dropping again because of, for example, other circuit characteristics, such as the load capacitance. The PSRR peak may be affected, for example, by such circuit features as the size of the power transistor, parasitics on controlling nodes, and the regulator architecture, all things usually decided and engineered to meet other critical requirements. Thus, small improvements in peak PSRR often come as expensive trade-offs with other important performance objectives and specifications.

PSRR in voltage regulators is usually very good within the bandwidth of the regulator feedback loop (in-band PSRR) but PSRR quickly degrades outside that bandwidth and reaches a peak that can be several tens of dB worse. Such poor peak PSRR translates to large residual noise on the regulated supply which often causes serious degradation in system performance. Improving PSRR often entails the use of large decoupling capacitances with considerable area costs and limitations on the regulator dynamics or expensive trade off with other critical parameters.

The supply noise compensation circuit aspects discussed herein drastically improve the peak PSRR without modifying the power transistor or the regulator loop dynamics. Therefore, no circuit performance tradeoffs with other objectives and specification are required.

In some implementations, a filter senses out-of-band supply noise in the unregulated supply, which is amplified, and then injected, as a current in opposite phase, to the regulator output node. As a result, out-of-band supply noise which would otherwise affect the regulated supply voltage, is effectively or at least partially compensated for. In some implementations, the circuit also functions as a current bleeder, thus reducing or eliminating inclusion of a separate current bleeder circuit. Accordingly, in some implementations, the circuit improves PSRR in a way that is particularly efficient for area and power.

The circuit here described significantly improves peak PSRR in low-drop-out voltage regulators. This result is achieved with minimum area overhead, little or no trade off with other important specifications and, in some implementations, without modification to the regulator power transistor. In some implementations, the dynamics of the regulator feedback loop are not affected or are not significantly affected.

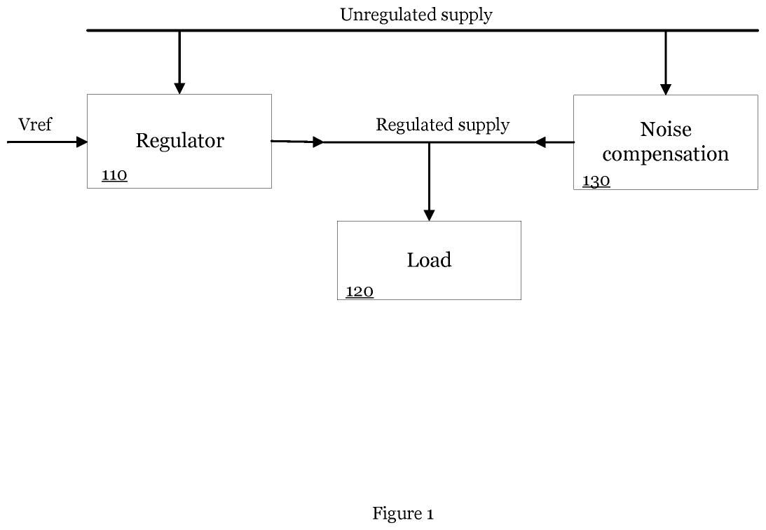

FIG. 1 illustrates a regulator circuit 100 comprising a regulator 110 coupled with a noise compensation circuit 130, which collectively provide a low noise high PSRR regulated voltage for a load 120 according to some implementations.

Regulator 110 receives a reference voltage at node Vref and receives an unregulated supply voltage. In some implementations, the “unregulated” supply voltage is unregulated or is less regulated with respect to the regulated supply voltage generated by regulator 110. Accordingly, in some implementations, the unregulated supply voltage has some voltage regulation. Based on the unregulated supply voltage and the reference voltage, regulator 110 generates a regulated supply voltage. The type of regulator and the architecture or topology of regulator 110 is not limited. For example, regulator 110 may be or include features similar or identical to any of a number of low dropout (LDO) regulator circuits. Regulator 110 may be or include features similar or identical to any of a number of other regulator circuits.

Noise compensation circuit 130 receives the unregulated supply voltage, and generates a noise compensation signal which is coupled onto the regulated supply voltage generated by regulator 110. In some implementations, noise compensation circuit 130 senses or detects noise on the unregulated supply voltage. In some implementations, noise compensation circuit 130 senses or detects high-frequency noise, or noise which is out of band of regulator 110.

Furthermore, noise compensation circuit 130 may be configured to generate the noise compensation signal based on the sensed or detected noise signal. As a result, the noise compensation signal has properties similar to the noise sensed or detected on the unregulated supply voltage, such that the noise compensation signal has an effect on the regulated supply voltage which is equal to, substantially equal to, or about equal to, and opposite of the effect on the regulated supply voltage of the noise sensed or detected on the unregulated supply voltage. Accordingly, the noise cancellation signal at least partially compensates for the noise of the unregulated voltage.

Consequently, the noise compensation signal generated by regulator 110 greatly improves PSRR in voltage regulator circuits without requiring large decoupling capacitances, thus saving important die area. Because noise compensation circuit 130 operates by sensing the unregulated supply and feeding the amplified, correcting signal directly to the regulator output node, noise compensation circuit 130 does not affect or does not significantly affect the regulator feedback loop dynamics. In addition, noise compensation circuit 130 may be used with any regulator architecture.

In some implementations, noise compensation circuit 130 also provides a current bleeder function providing a minimum current load to regulator 110. Accordingly, by replacing a traditional current bleeder, in some implementations, noise compensation circuit 130 does not require any additional current.

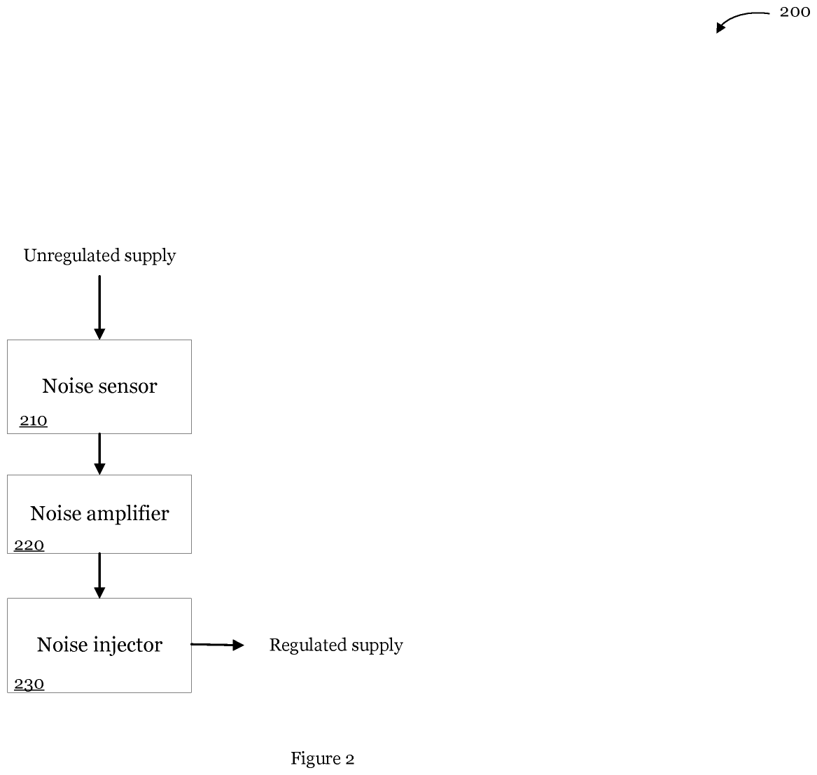

FIG. 2 illustrates a noise compensation circuit 200 according to some implementations. Noise compensation circuit 200 includes noise sensor circuit 210, noise amplification circuit 220, and noise injection circuit 230. In some implementations, noise compensation circuit 200 is configured to sense noise from an unregulated supply voltage and to inject a corresponding canceling noise signal onto a regulated supply voltage, where the regulated supply voltage is generated, for example, by a regulator circuit based on the unregulated supply voltage.

Noise sensor circuit 210 is configured to sense or detect noise in an unregulated supply voltage. In some implementations, noise sensor circuit 210 is configured to sense or detect noise in a frequency bandwidth greater than a bandwidth of the regulator circuit which generates the regulated supply voltage. In some implementations, noise sensor circuit 210 is configured to generate a noise signal based on the sensed or detected noise. Nonlimiting examples of noise sensor circuits are discussed elsewhere herein.

Noise amplification circuit 220 is configured to receive the noise signal generated by noise sensor circuit 210. In addition, noise amplification circuit 220 is configured to amplify the received noise signal to generate an amplified noise signal. Nonlimiting examples of noise amplification circuits are discussed elsewhere herein.

Noise injection circuit 230 is configured to receive the amplified noise signal from noise amplification circuit 220. In addition, noise injection circuit 230 is configured to generate a noise injection signal corresponding with the amplified noise signal, and to inject the noise injection signal onto the regulated supply voltage. Noise injection circuits are discussed elsewhere herein.

The noise sensor circuit 210, the noise amplification circuit 220, and the noise injection circuit 230 are collectively configured to generate and inject a signal onto the regulated supply voltage, where the signal at least partially cancels or compensates for noise on the regulated supply voltage present as a result of the noise on the unregulated supply voltage.

Since the noise compensation circuit 200 senses and responds to the unregulated supply noise, no feedback loop is present. As a result, its dynamics can be made very fast to be effective even at very high noise frequencies.

Many voltage regulators use current bleeders, for example, to guarantee a minimum load current on the regulated voltage node and improve feedback loop stability of the regulator circuit. In some implementations, noise compensating circuit 200 functions as a current bleeder circuit, thus, avoiding any additional current consumption overhead and minimizing the area footprint.

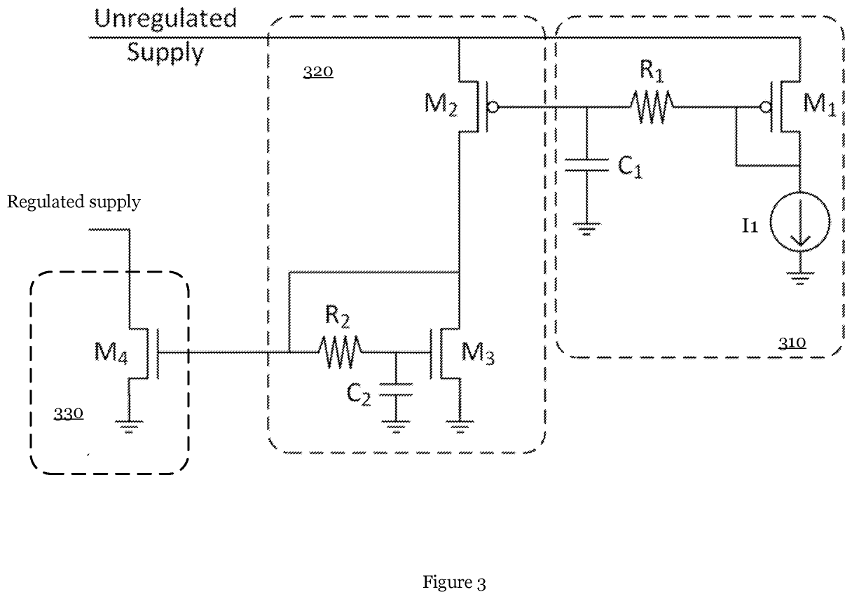

FIG. 3 illustrates a noise compensation circuit 300 according to some implementations. Noise compensation circuit 300 includes bias voltage generation circuit 310, noise amplification circuit 320, and transconductance stage 330. Noise compensation circuit 300 includes circuitry which performs the functions of noise sensor circuit 210, noise amplification circuit 220, and noise injection circuit 230. Noise compensation circuit 300 and its components illustrate circuit concepts and principles which may be used in certain implementations. Numerous alternative implementations are contemplated.

Bias voltage generation circuit 310 includes transistor M1 coupled to the unregulated supply in a diode connected configuration. In this implementation, bias voltage generation circuit 310 also includes a ground-referenced low-pass filter comprising resistor R1 and capacitor C1.

Transistor M1 generates a bias voltage at its gate based on the unregulated supply voltage and based on the current of current generator I1. In addition, an input of the low-pass filter is connected to the gate of transistor M1, and an output of the low-pass filter is connected to the gate of transistor M2 of noise amplification circuit 320. Also, because the low-pass filter is referenced to ground, the transistor M2 is effectively a common-gate stage, at least in frequency bands of interest.

Accordingly, from the unregulated supply point of view, this architecture results in a common-gate gain stage capable of sensing noise on the unregulated supply at frequencies higher than the pole set by the low pass filter. In some implementations, the pole is positioned at a frequency 1/X times the unity gain bandwidth of the regulator feedback loop, where X is the total gain of the noise compensation circuit 300. In some implementations, the bandwidth of the low pass filter is about equal to the frequency of minimum PSRR of regulator. In some implementations, the bandwidth of the low pass filter is about equal to and is less than the frequency of minimum PSRR of regulator.

As a result, the architecture provides a PMOS current mirror comprising transistors M1 and M2, where bias voltage generation circuit 310 generates a low bandwidth bias voltage at the gate of transistor M2. As a result, high-frequency noise on the unregulated supply voltage causes a noise current signal to be generated by transistor M2 of noise amplification circuit 320, where the noise current signal is generated with a gain of the transconductance of transistor M2 (gm M2)

Noise amplification circuit 320 also includes diode connected NMOS transistor M3, forms an active load with resistor R2 and capacitor C2. Resistor R2 and capacitor C2 form a low-pass filtered gate bias voltage at the gate of transistor M3. In some implementations, R1C1 is about equal to R2C2. The architecture of noise amplification circuit 320 provides a high frequency transconductance gain of the noise current signal from transistor M2 to generate a noise voltage signal at the drain of transistor M3 with a high frequency gain. In some implementations, the high frequency gain is equal to, substantially equal to, or about equal to the transconductance of transistor M2 (gm M2) times the drain to source resistance of transistor M3 (Rds M3) in parallel with the drain to source resistance of transistor M2 (Rds M2).

Transconductance stage 330 receives the noise voltage signal and generates a current noise cancellation signal which is injected into the regulated supply voltage. The current noise cancellation signal is generated with an inverting gain equal to the transconductance of transistor M4 (−gm M4).

Accordingly, noise compensation circuit 300 generates a noise cancellation signal equal to the noise of the unregulated supply voltage times (gm M2)×(Rds M2∥Rds M3∥R2)×1/(gm M4).

In some implementations, one or more of the gain factors of noise compensation circuit 300 are programmable. For example, one or more transistors of noise compensation circuit 300 may include multiple segments or legs which may be selectively connected or disconnected to the circuit to program the gain of the noise compensation circuit 300. For example, in some implementations, a regulator circuit using noise compensation circuit 300 undergoes a calibration sequence to determine a gain for noise compensation circuit 300 which preferentially compensates for noise in the regulated supply voltage generated as a result of noise in the unregulated supply voltage.

Since the noise compensating circuit senses and responds to the unregulated supply noise, no feedback loop is present. As a result, its dynamics can be made very fast to be effective even at very high noise frequencies.

Many voltage regulators use current bleeders, for example, to guarantee a minimum load current on the regulated voltage node and improve feedback loop stability of the regulator circuit. Since noise compensating circuit 300 functions as a current mirror at low frequencies, it is also effectively a current bleeder circuit, thus, in some implementations, avoiding any additional current consumption overhead and minimizing the area footprint.

In some implementations, noise compensation circuit 300 is used with a regulator having a PMOS output transistor driving the regulated supply. A beneficial aspect of noise compensation circuit 300 used with such a regulator is that the gain of the noise from the unregulated supply to the regulated supply from noise compensation circuit 300 tracks the noise from the unregulated supply to the regulated supply through the PMOS output transistor across process, voltage, and temperature variations.

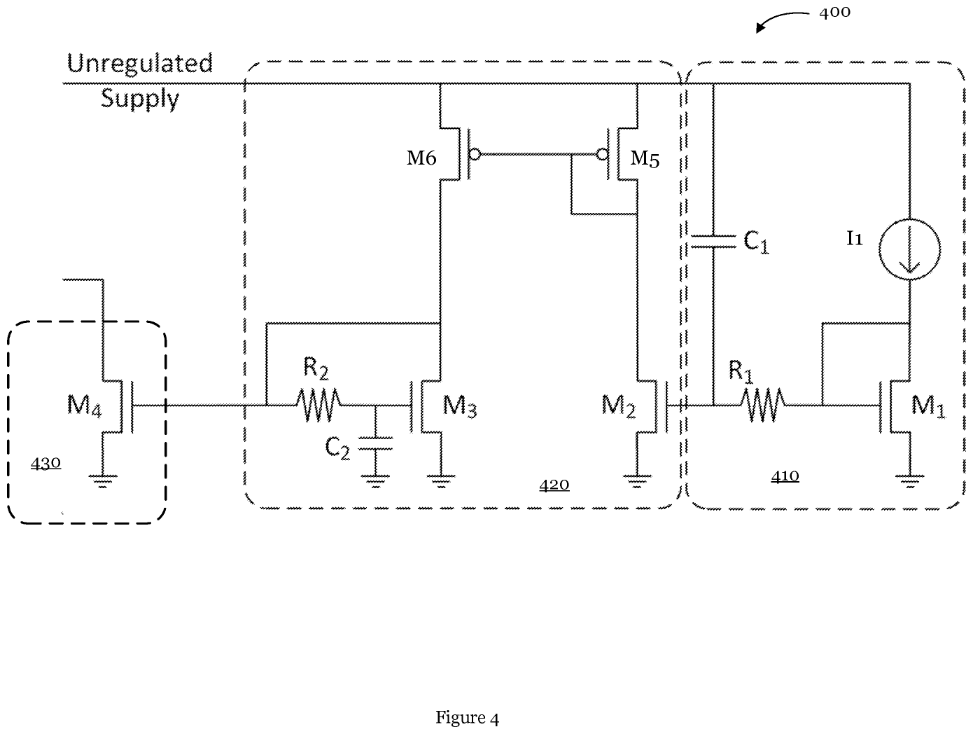

FIG. 4 illustrates a noise compensation circuit 400 according to some implementations. Noise compensation circuit 400 includes bias voltage generation and noise coupling circuit 410, noise amplification circuit 420, and transconductance stage 430. Noise compensation circuit 400 includes circuitry which performs the functions of noise sensor circuit 210, noise amplification circuit 220, and noise injection circuit 230. Noise compensation circuit 400 and its components illustrate circuit concepts and principles which may be used in certain implementations. Numerous alternative implementations are contemplated.

Bias voltage generation and noise coupling circuit 410 includes transistor M1 coupled to ground in a diode connected configuration. In this implementation, bias voltage generation and noise coupling circuit 410 also includes a low-pass filter referenced to the unregulated supply voltage, where the low-pass filter includes comprising resistor R1 and capacitor C1.

Transistor M1 generates a bias voltage at its gate based on the current of current generator I1. In addition, an input of the low-pass filter is connected to the gate of transistor M1, and an output of the low-pass filter is connected to the gate of transistor M2 of noise amplification circuit 420. In addition, because capacitor C1 is connected to the unregulated supply voltage, high-frequency noise of the unregulated supply voltage is coupled to the output of the low-pass filter.

Accordingly, from the unregulated supply point of view, this architecture results in a common-gate gain stage capable of sensing noise on the unregulated supply at frequencies higher than the pole set by the low pass filter. In some implementations, the pole is positioned at a frequency 1/X times the unity gain bandwidth of the regulator feedback loop, where X is the total gain of the noise compensation circuit 400. In some implementations, the bandwidth of the low pass filter is about equal to the frequency of minimum PSRR of regulator. In some implementations, the bandwidth of the low pass filter is about equal to and is less than the frequency of minimum PSRR of regulator.

As a result, the architecture provides an NMOS current mirror comprising transistors M1 and M2, where bias voltage generation and noise coupling circuit 410 generates a low bandwidth bias voltage at the gate of transistor M2 onto which noise of the unregulated supply voltage is coupled. As a result, high-frequency noise on the unregulated supply voltage causes a noise current signal to be generated by transistor M2 of noise amplification circuit 420, where the noise current signal is generated with a gain of the transconductance of transistor M2 (gm M2)

Noise amplification circuit 420 also includes diode connected PMOS transistor M5 which forms a current mirror with PMOS transistor M6. Consequently, the noise current signal is mirrored by PMOS transistors M5 and M6 to form a mirrored noise current signal. In some implementations, the current mirror provides a gain or amplification. We can call that gain gM5M6.

Noise amplification circuit 420 also includes diode connected NMOS transistor M3, which forms an active load with resistor R2 and capacitor C2. Resistor R2 and capacitor C2 form a low-pass filtered gate bias voltage at the gate of transistor M3. In some implementations, R1C2 is about equal to R2C2. The architecture of noise amplification circuit 420 provides a high frequency gain of the noise current signal from transistor M2 to generate a noise voltage signal at the drain of transistor M3 with a high frequency gain. In some implementations, the high frequency gain is equal to, substantially equal to, or about equal to the drain to source resistance of transistor M3 (Rds M3) in parallel with the drain to source resistance of transistor M6 (Rds M6).

Transconductance stage 430 receives the noise voltage signal and generates a current noise cancellation signal which is injected into the regulated supply voltage. The current noise cancellation signal is generated with an inverting gain equal to the transconductance of transistor M4 (−gm M4).

Accordingly, noise compensation circuit 400 generates a noise cancellation signal equal to the noise of the unregulated supply voltage times (gm M2)×(gM5M6)×(Rds M6∥Rds M3∥R2)×1/(gm M4).

In some implementations, one or more of the gain factors of noise compensation circuit 400 are programmable. For example, one or more transistors of noise compensation circuit 400 may include multiple segments or legs which may be selectively connected or disconnected to the circuit to program the gain of the noise compensation circuit 400. For example, in some implementations, a regulator circuit using noise compensation circuit 400 undergoes a calibration sequence to determine a gain for noise compensation circuit 400 which preferentially compensates for noise in the regulated supply voltage generated as a result of noise in the unregulated supply voltage.

Since the noise compensating circuit senses and responds to the unregulated supply noise, no feedback loop is present. Furthermore, since noise compensating circuit 400 functions as a current mirror at low frequencies, it is also effectively a current bleeder circuit.

In some implementations, noise compensation circuit 400 is used with a regulator having a NMOS output transistor driving the regulated supply. A beneficial aspect of noise compensation circuit 400 used with such a regulator is that the gain of the noise from the unregulated supply to the regulated supply from noise compensation circuit 400 tracks the noise from the unregulated supply to the regulated supply through the NMOS output transistor across process, voltage, and temperature variations.

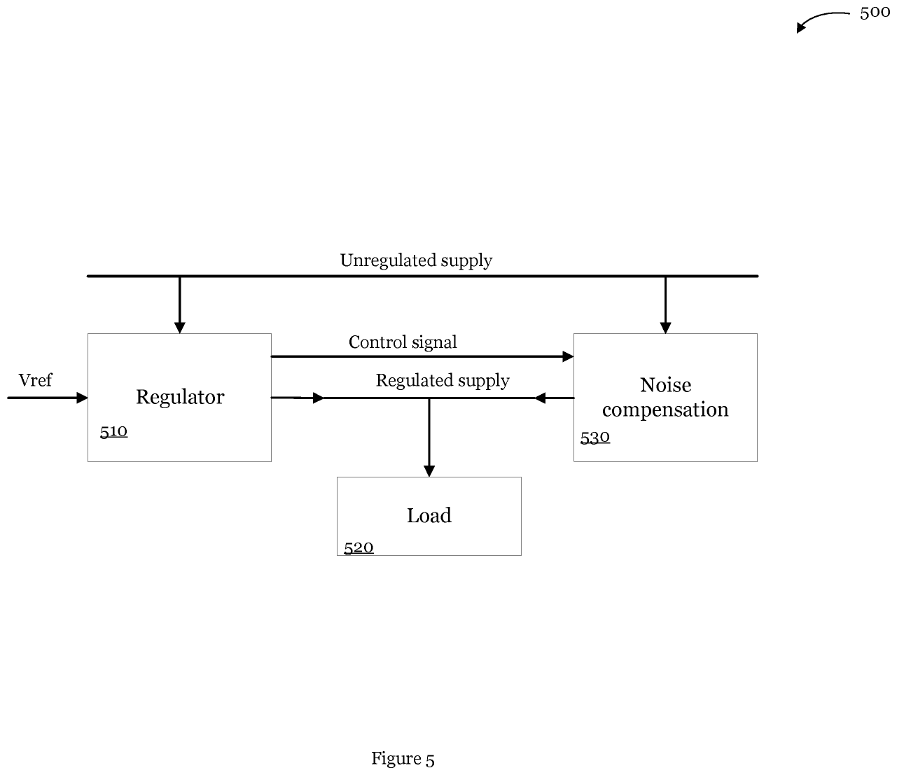

FIG. 5 illustrates a regulator circuit 500 comprising a regulator 510 coupled with a noise compensation circuit 530, which collectively provide a low noise high PSRR regulated voltage for a load 520 according to some implementations.

Regulator 510 receives a reference voltage at node Vref and receives an unregulated supply voltage. Based on the unregulated supply voltage and the reference voltage, regulator 510 generates a regulated supply voltage. Regulator 510 is configured to generate a control signal which it internally uses to generate the regulated supply voltage. For example, regulator 510 may generate the control signal as part of a feedback loop causing the regulated supply voltage to have a desired voltage value.

Noise compensation circuit 530 receives the unregulated supply voltage and receives the control signal. In addition, noise compensation circuit 530 generates a noise compensation signal based on the unregulated supply voltage and based on the received control signal. The noise compensation signal is coupled onto the regulated supply voltage generated by regulator 510. In some implementations, noise compensation circuit 530 senses or detects noise on the unregulated supply voltage. In some implementations, noise compensation circuit 530 senses or detects high-frequency noise, or noise which is out of band of regulator 510.

Furthermore, because the noise compensation signal is based on the sensed or detected noise signal, the noise compensation signal has properties similar to the noise sensed or detected on the unregulated supply voltage. Consequently, the noise compensation signal has an effect on the regulated supply voltage which is equal to, substantially equal to, or about equal to, and opposite of the effect on the regulated supply voltage of the noise sensed or detected on the unregulated supply voltage. Accordingly, the noise cancellation signal at least partially compensates for the noise of the unregulated voltage.

As a result, the noise compensation signal generated by regulator 510 greatly improves PSRR in voltage regulator circuits without requiring large decoupling capacitances, thus saving important die area. Because noise compensation circuit 530 operates by sensing the unregulated supply and feeding the amplified, correcting signal directly to the regulator output node, in some implementations, noise compensation circuit 530 does not affect or does not significantly affect the regulator feedback loop dynamics.

In some implementations, noise compensation circuit 530 also provides a current bleeder function providing a minimum current load to regulator 510. Accordingly, by replacing a traditional current bleeder, in some implementations, noise compensation circuit 530 does not require any additional current.

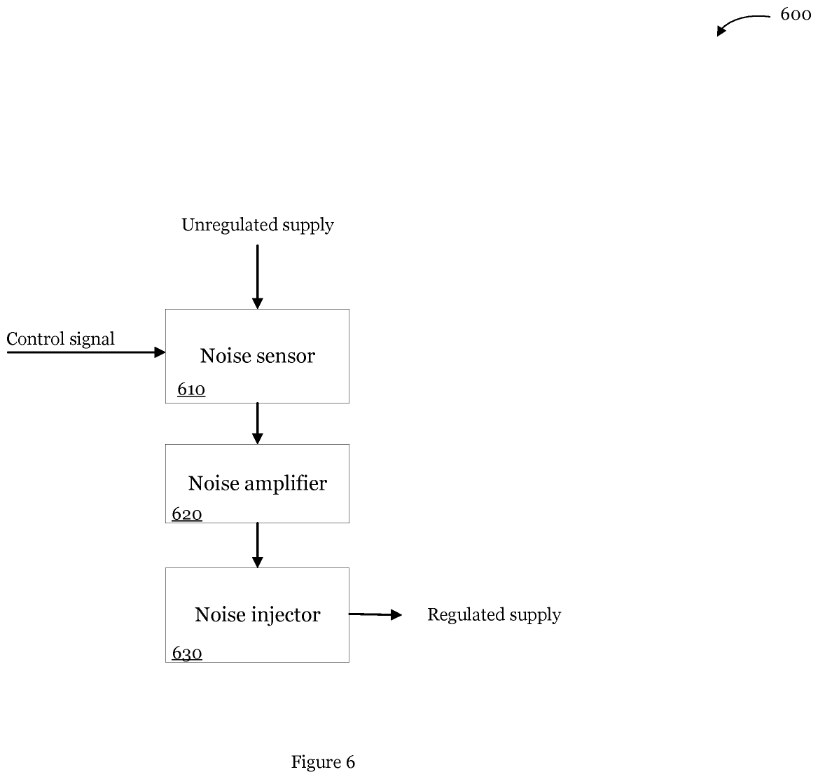

FIG. 6 illustrates a noise compensation circuit 600 according to some implementations. Noise compensation circuit 600 includes noise sensor circuit 610, noise amplification circuit 620, and noise injection circuit 630. In some implementations, noise compensation circuit 600 is configured to sense noise from an unregulated supply voltage and to inject a corresponding canceling noise signal onto a regulated supply voltage, where the regulated supply voltage is generated, for example, by a regulator circuit based on the unregulated supply voltage.

Noise sensor circuit 610 is configured to receive a control signal from the regulator circuit, and to sense or detect noise in an unregulated supply voltage based partly on the control signal. In some implementations, noise sensor circuit 610 is configured to sense or detect noise in a frequency bandwidth greater than a bandwidth of the regulator circuit which generates the regulated supply voltage. In some implementations, noise sensor circuit 610 is configured to generate a noise signal based on the sensed or detected noise. Nonlimiting examples of noise sensor circuits are discussed elsewhere herein.

Noise amplification circuit 620 is configured to receive the noise signal generated by noise sensor circuit 610. In addition, noise amplification circuit 620 is configured to amplify the received noise signal to generate an amplified noise signal. Nonlimiting examples of noise amplification circuits are discussed elsewhere herein.

Noise injection circuit 630 is configured to receive the amplified noise signal from noise amplification circuit 620. In addition, noise injection circuit 630 is configured to generate a noise injection signal corresponding with the amplified noise signal, and to inject the noise injection signal onto the regulated supply voltage. Noise injection circuits are discussed elsewhere herein.

The noise sensor circuit 610, the noise amplification circuit 620, and the noise injection circuit 630 are collectively configured to generate and inject a signal onto the regulated supply voltage, where the signal at least partially cancels or compensates for noise on the regulated supply voltage present as a result of the noise on the unregulated supply voltage.

In some implementations, since the noise compensation circuit 600 senses and responds to the unregulated supply noise which is out of the bandwidth of the regulator, effectively no feedback loop is present. As a result, its dynamics can be made very fast to be effective even at very high noise frequencies. In addition, in some implementations, noise compensating circuit 600 functions as a current bleeder circuit, thus, avoiding any additional current consumption overhead and minimizing the area footprint.

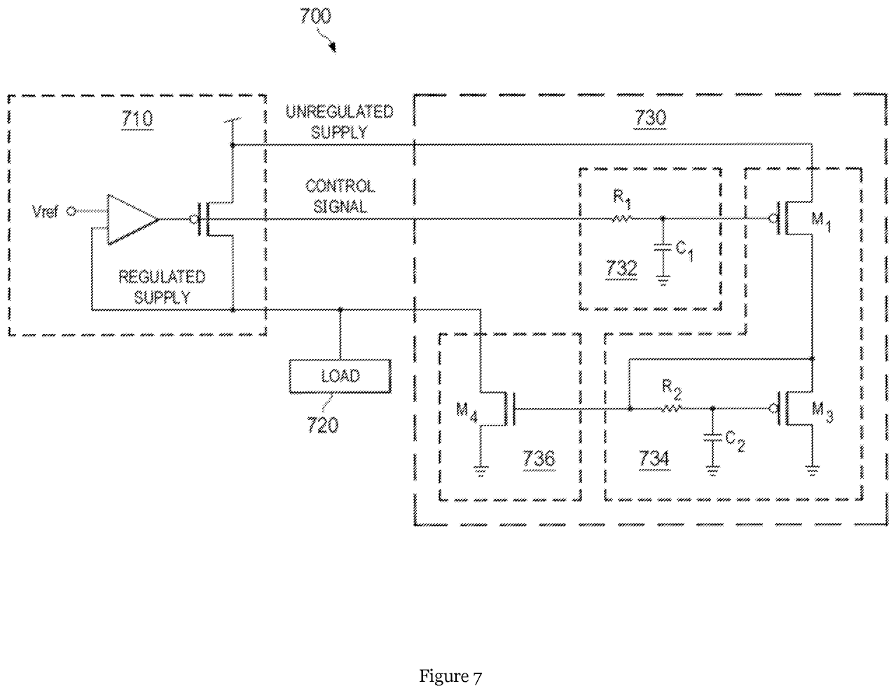

FIG. 7 illustrates a regulator circuit 700 comprising a regulator 710 coupled with a noise compensation circuit 730, which collectively provide a low noise high PSRR regulated voltage for a load 720 according to some implementations.

Regulator 710 receives a reference voltage at node Vref and receives an unregulated supply voltage. Based on the unregulated supply voltage and the reference voltage, regulator 710 generates a regulated supply voltage. Regulator 710 is also configured to generate a control signal which it uses to generate the regulated supply voltage.

Noise compensation circuit 730 receives the unregulated supply voltage and receives the control signal. In addition, noise compensation circuit 730 generates a noise compensation signal based on the unregulated supply voltage and based on the received control signal. The noise compensation signal is coupled onto the regulated supply voltage generated by regulator 710.

Noise compensation circuit 730 includes bias voltage generation circuit 732, noise amplification circuit 734, and transconductance stage 736. Noise compensation circuit 730 and its components illustrate circuit concepts and principles which may be used in certain implementations. Numerous alternative implementations are contemplated.

Bias voltage generation circuit 732 includes a ground-referenced low-pass filter comprising resistor R1 and capacitor C1. The low-pass filter filters the control signal received from regulator 710 to generate a low frequency bias voltage for transistor M1 of noise amplification circuit 734.

Accordingly, this architecture results in gm gain stage capable of sensing noise on the unregulated supply at frequencies higher than the pole set by the low pass filter. In some implementations, the pole is positioned at a frequency 1/X times the unity gain bandwidth of the regulator feedback loop, where X is the total gain of the noise compensation circuit 730. In some implementations, the bandwidth of the low pass filter is about equal to the frequency of minimum PSRR of regulator. In some implementations, the bandwidth of the low pass filter is about equal to and is less than the frequency of minimum PSRR of regulator.

As a result, high-frequency noise on the unregulated supply voltage causes a noise current signal to be generated by transistor M1 of noise amplification circuit 734, where the noise current signal is generated with a gain of the transconductance of transistor M1 (gm M1)

Noise amplification circuit 734 also includes diode connected NMOS transistor M3, which forms an active load with resistor R2 and capacitor C2. Resistor R2 and capacitor C2 form a low-pass filtered gate bias voltage at the gate of transistor M3. In some implementations, R1C1 is about equal to R2C2. The architecture of noise amplification circuit 734 provides a high frequency gain of the noise current signal from transistor M1 to generate a noise voltage signal at the drain of transistor M3 with a high frequency gain. In some implementations, the high frequency gain is equal to, substantially equal to, or about equal to the drain to source resistance of transistor M3 (Rds M3) in parallel with the drain to source resistance of transistor M1 (Rds M1) and resistor R2.

Transconductance stage 736 receives the noise voltage signal and generates a current noise cancellation signal which is injected into the regulated supply voltage. The current noise cancellation signal is generated with an inverting gain equal to the transconductance of transistor M4 (−gm M4).

Accordingly, regulator circuit 700 generates a noise cancellation signal equal to the noise of the unregulated supply voltage times (gm M1)×(Rds M1∥Rds M3∥R2)×1/(gm M4).

In some implementations, one or more of the gain factors of regulator circuit 700 are programmable. For example, one or more transistors of regulator circuit 700 may include multiple segments or legs which may be selectively connected or disconnected to the circuit to program the gain of the regulator circuit 700. For example, in some implementations, a regulator circuit using regulator circuit 700 undergoes a calibration sequence to determine a gain for regulator circuit 700 which preferentially compensates for noise in the regulated supply voltage generated as a result of noise in the unregulated supply voltage. In some implementations, the gain of the noise compensation circuit 730 is designed to be low within the bandwidth of regulator 710 to avoid the noise compensation circuit 730 having an adverse effect on the loop dynamics of the regulator loop.

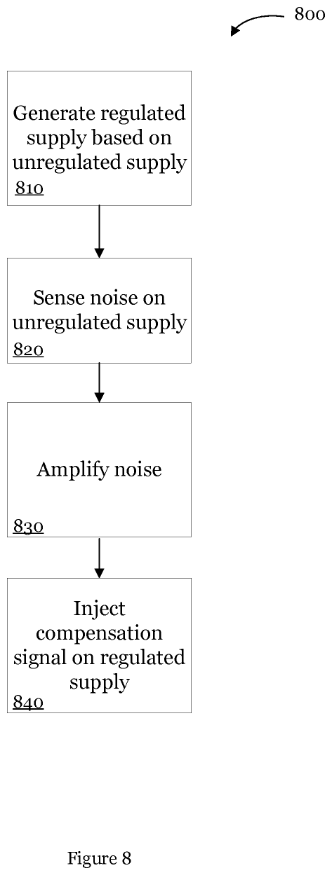

FIG. 8 is a flowchart diagram illustrating a method 800 of operating a regulator circuit coupled with a noise compensation circuit according to some implementations. In some implementations, regulator circuit 100 is configured to perform method 800 or a method having similar or identical aspects. In some implementations, regulator circuit 700 is configured to perform method 800 or a method having similar or identical aspects.

At block 810, a regulated supply voltage is generated. For example, a regulator, such as regulator 110 and/or regulator 710 is configured to generate a regulated supply voltage based on an unregulated supply voltage. In some implementations, the regulator is configured to generate the regulated supply voltage additionally based on a reference voltage. In some implementations, the regulator is configured to additionally generate a control signal.

At block 820, noise on the unregulated supply voltage is sensed or detected. For example, a noise compensation circuit, for example having features similar or identical to noise compensation circuit 300, noise compensation circuit 400, and/or noise compensation circuit 730 may sense or detect noise on the unregulated supply voltage. For example, using circuits and techniques discussed above with reference to noise compensation circuit 300, noise compensation circuit 400, and/or noise compensation circuit 730, noise on the unregulated supply voltage may be sensed or detected.

At block 830, the noise sensed on the unregulated supply voltage is amplified. For example, a noise compensation circuit, having features similar or identical to noise compensation circuit 300, noise compensation circuit 400, and/or noise compensation circuit 730 may amplify the noise sensed or detect on the unregulated supply voltage at block 820. For example, using circuits and techniques discussed above with reference to noise compensation circuit 300, noise compensation circuit 400, and/or noise compensation circuit 730, noise sensed or detected on the unregulated supply voltage may be amplified.

At block 840, the noise sensed or detected on the unregulated supply voltage amplified at block 830 may be injected onto the regulated supply voltage. For example, a transconductance stage having features similar or identical to as transconductance stage 330, transconductance stage 430, and/or transconductance stage 736 may be used to inject the amplified noise sensed or detected on the unregulated supply voltage. As a result, in some implementations, the amplified noise injected onto the regulated supply voltage has an effect on the regulated supply voltage which is equal to, substantially equal to, or about equal to, and opposite of the effect on the regulated supply voltage of the noise sensed or detected on the unregulated supply voltage. Accordingly, the amplified noise at least partially compensates for the noise of the unregulated voltage.

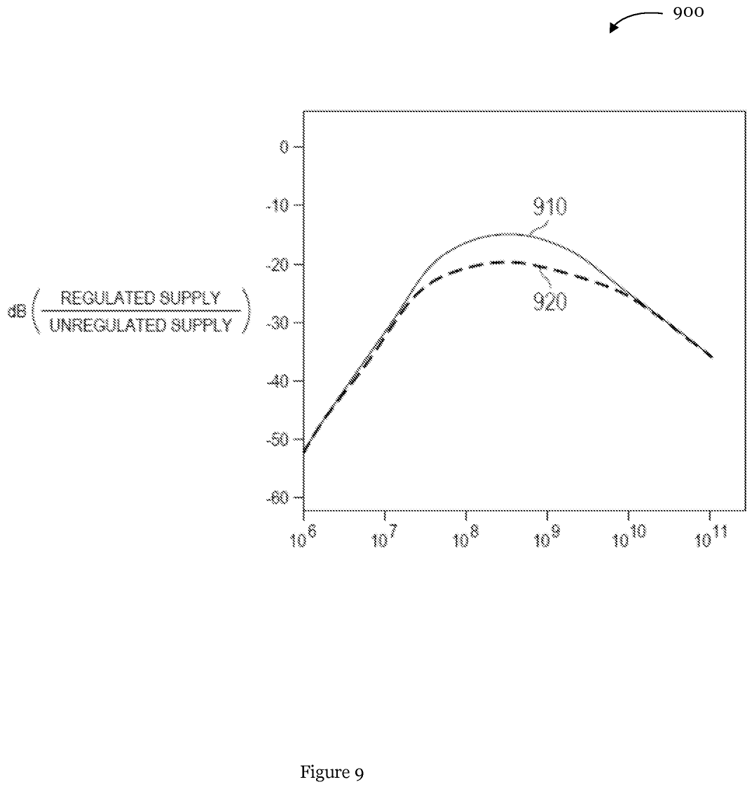

FIG. 9 is a graphical representation 900 of PSRR for a regular circuit indicating supply noise rejection across frequency of a regulator circuit having a noise compensation circuit which may be selectively enabled. The PSRR performance of the regulator circuit with the noise compensation circuit not enabled is shown with graph trace 910, and the PSRR performance of the regulator circuit having the noise compensation circuit enabled is shown with graph trace 920. The minimum supply noise rejection for the regulator circuit having the noise compensation circuit not enabled is at about 200 MHz and indicates a rejection of about 16 dB. The minimum supply noise rejection for the regulator circuit having the noise compensation circuit enabled is at about 200 MHz and indicates a rejection of about 24 dB. Accordingly, the regulator circuit having the advantageous circuit features and aspects discussed herein have an improved PSRR performance of about 8 dB.

It is to be understood that the data illustrated in FIG. 9 represents a particular example. Other circuit scenarios result in better increased performance than that illustrated in FIG. 9.

One general aspect is a regulator circuit configured to generate a regulated voltage for a load based on an unregulated supply voltage, the regulator circuit including a regulator, configured to receive the unregulated supply voltage and to generate the regulated voltage based on the unregulated supply voltage, where in the regulated voltage includes noise from the unregulated supply voltage; and a noise compensation circuit configured to amplify noise of the unregulated supply voltage, and to inject the amplified noise onto the regulated voltage.

Implementations may include one or more of the following features. The regulator circuit, where the regulator generates the regulated voltage using a feedback loop having a bandwidth, and where the injected amplified sensed noise as frequency components which are outside of the bandwidth of the feedback loop. The regulator circuit, where the noise compensation circuit includes a noise sensor circuit configured to sense noise in the unregulated supply voltage, and to generate a noise signal based on the sensed noise. The regulator circuit, where the noise compensation circuit includes a noise amplification circuit configured to receive the noise signal, and to amplify the noise signal to generate an amplified noise signal. The regulator circuit, where the noise compensation circuit includes a noise injection circuit configured to generate a noise injection signal corresponding with the amplified noise signal, and to inject the noise injection signal onto the regulated voltage. The regulator circuit, where the noise injection signal at least partially compensates for the noise in the regulated voltage from the unregulated supply voltage. The regulator circuit, where the noise injection circuit includes a transconductance stage. The regulator circuit, where the noise injection circuit includes an inverting stage. The regulator circuit, where the noise sensor circuit includes a bias voltage generation circuit. The regulator circuit, where the noise compensation circuit includes a plurality of amplification stages.

Another general aspect is a noise compensation circuit configured to compensate noise in a regulated voltage generated from an unregulated supply voltage, the noise compensation circuit including a noise amplification circuit configured to amplify noise from the unregulated supply voltage based; and a noise injection circuit configured to generate a noise injection signal corresponding with the amplified noise, and to inject the noise injection signal onto the regulated voltage.

Implementations may include one or more of the following features. The noise compensation circuit, further including a noise sensor circuit configured to sense noise in the unregulated supply voltage, and to generate a noise signal based on the sensed noise. The noise compensation circuit, where the noise injection signal at least partially compensates for the noise in the regulated voltage from the unregulated supply voltage. The noise compensation circuit, where the noise injection circuit includes a transconductance stage. The noise compensation circuit, where the noise injection circuit includes an inverting stage. The noise compensation circuit, where the noise amplification circuit includes a plurality of amplification stages.

Another general aspect is a method of using a regulator circuit, the method including generating a regulated voltage based on an unregulated supply voltage, where in the regulated voltage includes noise from the unregulated supply voltage; amplifying noise of the unregulated supply voltage; and injecting the amplified noise onto the regulated voltage.

Implementations may include one or more of the following features. The method, where the injected amplified noise at least partially compensates for the noise in the regulated voltage from the unregulated supply voltage. The method, where amplifying the noise includes inverting a polarity of the noise. The method, where amplifying the noise includes amplifying the noise in a plurality of amplification stages.

While this invention has been described with reference to illustrative implementations, this description is not intended to be construed in a limiting sense. Various modifications and combinations of the illustrative implementations, as well as other implementations of the invention, will be apparent to persons skilled in the art upon reference to the description. It is therefore intended that the appended claims encompass any such modifications or implementations.

What is claimed is:

1. A regulator circuit configured to generate a regulated voltage for a load based on an unregulated supply voltage, the regulator circuit comprising:
a regulator, configured to receive the unregulated supply voltage and to generate the regulated voltage based on the unregulated supply voltage, where in the regulated voltage comprises noise from the unregulated supply voltage; and
a noise compensation circuit configured to amplify noise of the unregulated supply voltage, and to inject the amplified noise onto the regulated voltage.

2. The regulator circuit of claim 1, wherein the regulator generates the regulated voltage using a feedback loop having a bandwidth, and wherein the injected amplified sensed noise as frequency components which are outside of the bandwidth of the feedback loop.

3. The regulator circuit of claim 1, wherein the noise compensation circuit comprises a noise sensor circuit configured to sense noise in the unregulated supply voltage, and to generate a noise signal based on the sensed noise.

4. The regulator circuit of claim 3, wherein the noise compensation circuit comprises a noise amplification circuit configured to receive the noise signal, and to amplify the noise signal to generate an amplified noise signal.

5. The regulator circuit of claim 4, wherein the noise compensation circuit comprises a noise injection circuit configured to generate a noise injection signal corresponding with the amplified noise signal, and to inject the noise injection signal onto the regulated voltage.

6. The regulator circuit of claim 5, wherein the noise injection signal at least partially compensates for the noise in the regulated voltage from the unregulated supply voltage.

7. The regulator circuit of claim 5, wherein the noise injection circuit comprises a transconductance stage.

8. The regulator circuit of claim 5, wherein the noise injection circuit comprises an inverting stage.

9. The regulator circuit of claim 3, wherein the noise sensor circuit comprises a bias voltage generation circuit.

10. The regulator circuit of claim 1, wherein the noise compensation circuit comprises a plurality of amplification stages.

11. A noise compensation circuit configured to compensate noise in a regulated voltage generated from an unregulated supply voltage, the noise compensation circuit comprising:
a noise amplification circuit configured to amplify noise from the unregulated supply voltage based; and
a noise injection circuit configured to generate a noise injection signal corresponding with the amplified noise, and to inject the noise injection signal onto the regulated voltage.

12. The noise compensation circuit of claim 11, further comprising a noise sensor circuit configured to sense noise in the unregulated supply voltage, and to generate a noise signal based on the sensed noise.

13. The noise compensation circuit of claim 11, wherein the noise injection signal at least partially compensates for the noise in the regulated voltage from the unregulated supply voltage.

14. The noise compensation circuit of claim 11, wherein the noise injection circuit comprises a transconductance stage.

15. The noise compensation circuit of claim 11, wherein the noise injection circuit comprises an inverting stage.

16. The noise compensation circuit of claim 11, wherein the noise amplification circuit comprises a plurality of amplification stages.

17. A method of using a regulator circuit, the method comprising:
generating a regulated voltage based on an unregulated supply voltage, where in the regulated voltage comprises noise from the unregulated supply voltage;
amplifying noise of the unregulated supply voltage; and
injecting the amplified noise onto the regulated voltage.

18. The method of claim 17, wherein the injected amplified noise at least partially compensates for the noise in the regulated voltage from the unregulated supply voltage.

19. The method of claim 17, wherein amplifying the noise comprises inverting a polarity of the noise.

20. The method of claim 17, wherein amplifying the noise comprises amplifying the noise in a plurality of amplification stages.
